(19) United States
(12) Patent Application Publication
(10) Pub. No.: US 2008/0021689 A1
(43) Pub. Date: Jan. 24, 2008

(54) Method for designing semiconductor integrated circuit and method of circuit simulation

(76) Inventors: Kyoji Yamashita, Osaka (JP); Daisaku Ikoma, Osaka (JP); Yasuyuki Sahara, Osaka (JP); Katsuhiro Ootani, Osaka (JP); Shinji Watanabe, Osaka (JP)

Correspondence Address: MCDERMOTT WILL & EMERY LLP, 600 13TH STREET, NW, WASHINGTON, DC, 20005-3096, US

(21) Appl. No.: 11/812,705

(22) Filed: Jun. 21, 2007

(30) Foreign Application Priority Data
Jul. 18, 2006 (JP) 2006-195125

(51) Int. Cl. G06F 17/50

(52) U.S. Cl. 703/14

(57) ABSTRACT

By using, as a model expression, an expression showing an inverse proportion between a change rate ΔIdsat/Idsat of saturated current value and a product of a gate protrusion length E1 and a gate width Wg of a transistor and a coefficient, modeling is executed for a transistor property that depends on the gate protrusion length. This provides a circuit simulation that takes into consideration the gate protrusion length of a gate electrode.

### BACKGROUND OF THE INVENTION

1. Technical Field

The present invention relates to a method for designing a semiconductor integrated circuit in which a multiplicity of MIS transistors are integrated.

2. Related Art

An LSI (Large Scale Integrated) represented by a microprocessor is a combination of a multiplicity of unit circuits generally referred to as cells, which have basic functions. In accordance with high integration and high performance for the LSI, CAD (Computer Aided Design) tools play increasingly important rolls for highly accurate circuit design of a cell, which is an essential part of circuit design of the LSI.

A circuit simulator is used as one of the CAD tools associated in high degree with design accuracy. The circuit simulator simulates operations of a designed cell and LSI on the basis of a netlist including connection information of elements such as MOS (Metal Oxide Semiconductor) transistor, capacitative elements, and resistance elements, and property information of respective elements such as transistor size (transistor width and length), a capacitance value, and a resistance value.

The netlist is generated by, for example, extracting, from the mask layout data of the designed cell, the property information and connection information of arranged elements using a layout parameter extractor (LPE).

In order to accurately reproduce the complicated an electric property of the MOS transistor on the circuit simulator, a large number of electric property expressions (hereinafter referred to as transistor models) are being developed as property information of the MOS transistor. In order to reproduce desired properties of a transistor by using a transistor model, it is required to optimize model parameters included in the transistor model in accordance with properties of the desired transistor, that is, to extract the model parameters.

In recent years, in development of a system LSI and so on, there is a need for further improvement in simulation accuracy of a circuit simulator. In particular, as refinement of semiconductor process progresses, the layout pattern and the arrangement of a circuit element greatly affect circuit performance. In particular, in a transistor with element isolation technology such as STI (Shallow Trench Isolation), a phenomenon occurs in which an electric current property of the transistor greatly changes because channel mobility changes depending on mechanical stress applied to the transistor from an insulation film for isolating elements. This draws attention as a factor to prevent improvement of accuracy in the circuit simulation.

Conventionally, in order to perform a circuit simulation taking into consideration stress applied to a transistor from an element isolating insulation film, circuit simulation is performed by defining the width of the element isolating insulation film and the length of an active region as indicators for stress applied to the transistor (see Japanese Patent Application Publication No. 2004-86546).

FIG. 13 is a plan view of a common MOS transistor, showing an example of model parameters used in a conventional circuit simulation. It is assumed that the MOS transistor has an active region 22 surrounded by a gate electrode 23 and an element isolating insulation film 25 and that active regions 24 are arranged in four sides of the active region 22 across the element isolating insulation film 25. In the conventional circuit simulation, a length 29 of the active region 22 (a length along a direction vertical to the gate electrode 23 in the active region 22) is used as an indicator for stress applied to the MOS transistor in addition to the gate length and width of the active region 22 (a length along a direction parallel to the gate electrode 23 in the active region 22). The length 29 of the active region 22 corresponds to a combination of the source length, channel length, and drain length. In FIG. 13, reference numeral 30 denotes the width of the element isolating insulation film 25, that is, the distance between an end of the active region 22 in the MOS transistor and the active region 24 adjacent the end in the gate width direction. In this specification, the gate width direction means a direction where the gate electrode 23 of the MOS transistor is oriented in a plane on the active region 22, and the gate length direction means a direction vertical to the gate width direction.

### SUMMARY OF THE INVENTION

However, ongoing refinement has posed a new problem; there is caused a great discrepancy of properties between an ideal independent transistor for extracting model parameters and a CMOS type transistor included in a cell of practical design. This has necessitated a new model parameter for highly accurate estimation of a transistor property.

In view of the above mentioned problems, it is an object of the present invention to provide a circuit simulation with improved accuracy by carrying out device modeling using a new model parameter.

A method for designing a semiconductor integrated circuit is disclosed herein. The semiconductor integrated circuit includes a transistor having an active region and a gate electrode crossing the active region and including a gate protrusion portion having a plan profile protruding beyond both sides of the active region. The method includes (a) executing modeling by using an inverse proportion between a change rate of a saturated current value of the transistor and a sum of a gate protrusion length and a product of a gate width of the transistor and a coefficient A, the gate protrusion length being the length of the gate protrusion portion.

This method provides modeling using a relatively simple model expression, thereby facilitating a simulation taking into consideration how stress applied to the channel from the gate protrusion portion affects the operation of the transistor. This enables highly accurate estimation of the operation of a semiconductor integrated circuit in comparison with conventional circuit simulation, thereby also realizing a reduction in time and cost required for designing the semiconductor integrated circuit.

A circuit simulation method of the present invention is a circuit simulation method of a semiconductor integrated circuit. The semiconductor integrated circuit includes a transistor having an active region and a gate electrode that crosses the active region and includes a gate protrusion portion having a plan profile protruding beyond both sides of the active region. The method includes the steps of: a step (a) of extracting, from mask layout data, transistor size data including a gate length, a gate width, a gate protrusion length of the gate protrusion portion, and the number of apexes obtained by subtracting the number of apexes positioned over the active region from apexes of the gate protrusion portion; a step (b) of inputting the transistor size data extracted in the step (a) to a circuit simulation execution means; a step (c) of obtaining device property data including a saturated current value by measuring electric properties of a plurality of actually measured transistors having different gate protrusion lengths; a step (d) of executing a parameter extraction with respect to a saturated current of the plurality of actually measured transistors from the device property data using the gate length and the gate width of the plurality of actually measured transistors, and a parameter of stress applied from the gate protrusion portion, the parameter including the gate protrusion length of the gate protrusion portion; a step (e) of inputting the parameter extracted in the step (d) to the circuit simulation execution means; and a step (f) of simulating an operation of the semiconductor integrated circuit with use of the transistor size data and a parameter inputted in the step (e), the simulation being executed by the circuit simulation execution means. In the step (c) and the step (d), modeling is executed with respect to each of the plurality of actually measured transistors by using an inverse proportion between a change rate of a saturated current value of each actually measured transistor and a sum of the gate protrusion length and a product of the gate width of each actually measured transistor and a coefficient A.

This method uses, when executing a parameter extraction from the gate protrusion portion by using a parameter of applied stress to a channel, a simple model expression showing an inverse proportion between the change rate of a saturated current value and a sum of the gate protrusion length and a product of the gate width of the actually measured transistor and a coefficient A. This enables a highly accurate simulation that into consideration effects to an operation of a transistor by stress applied to the channel from the gate protrusion portion can be performed.

Thus, the operation of an integrated circuit can be simulated with high accuracy by modeling change of a transistor property depending on a gate protrusion length with use of a simple model expression. Also for a complicated gate wiring patterns existing in actual LSIs, the model parameter extraction means is simplified and the amount of calculation is reduced by using such a procedure that assumes, for a gate electrode with a gate contact pad and a gate electrode with a bent wiring, that the gate protrusion length is infinite. This facilitates a highly accurate circuit simulation.

### BRIEF DESCRIPTION OF THE DRAWINGS

FIG. 1 is a plan view explaining how stress is applied to an end of a gate.

FIGS. 2A and 2B are perspective views explaining a relation between stress and carrier mobility in transistors.

FIG. 3 is a plan view showing an example of a pattern for evaluating effects given to a transistor property by a gate protrusion length.

FIG. 4 is a graph showing a relation between a gate protrusion length E1 and a change rate of a saturated current value.

FIG. 5 is a view showing a relation in a coefficient regarding a gate width Wg, a correlation coefficient, and an error in an expression (3).

FIGS. 6A to 6C are views showing examples of patterns of transistors having a gate electrode with a gate contact pad.

FIG. 7A is a view showing a pattern of a transistor whose one end has a gate contact pad and whose another end has a L type bent wiring 113, and 7B is a view showing a pattern of a transistor whose one end has a gate contact pad and whose another end has a T type bent wiring.

FIG. 8A is a view showing a measurement result of a relation between the shapes of the gate contact pads and saturated current value of the transistors, and FIG. 8B is a view showing a measurement result of a relation between a gate protrusion length and a saturated current value when the gate contact pads and the bent wirings are not provided.

FIGS. 9A and 9B are views respectively showing a relation between the shape of the L type bent wiring shown in FIG. 7A and a saturated current value of a unit length, and a relation between the shape of the T type bent wiring shown in FIG. 7B and a saturated current value of a unit length.

FIGS. 10A and 10B are views respectively explaining how stresses are applied to the L type and the T type bent wirings.

FIGS. 11A and 11B are views showing a pattern classification applied to a complicated gate wiring pattern in an actually designed LSI.

FIG. 12 is a block diagram showing a configuration of a circuit simulation device according to a third embodiment.

FIG. 13 is a plan view showing a common MOS transistor.

### DESCRIPTION OF THE PREFERRED EMBODIMENTS

The inventors of the present invention searched a model parameter which improves the accuracy of a circuit simulation. As a result, the inventors realized that the a property of a MOS (MIS) transistor varies depending on the length of a part of the gate electrode 23 that protruded from the active region 22 on the insulation film for isolating elements 25 (hereinafter referred to as a gate protrusion length). A method for executing a device modeling taking into consideration the gate protrusion length will be explained below.

### First Embodiment

### —Method for Designing—

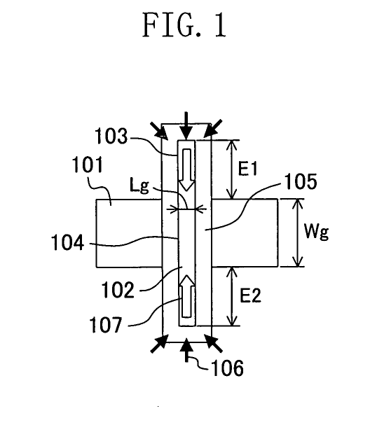

FIG. 1 is a plan view explaining how stress is applied to an end of a gate. The figure shows a MOS transistor (hereinafter simply referred to as a transistor 104) including an active region 101 formed on a semiconductor substrate, a gate electrode 102 formed on the semiconductor substrate by interleaving a gate insulation film, and a side wall 105 formed on a side of the gate electrode 102. The side wall 105 is made of, for example, SiN. In FIG. 1, reference numeral 103 denotes a gate protrusion portion, reference numeral 106 denotes compressive stress arising in the side wall 105 when the side wall 105 contracts, and reference numeral 107 denotes compressive stress applied to the gate protrusion portion 103 from the side wall 105. In addition, Lg denotes a gate length, Wg denotes a gate width, E1 and E2 denote gate protrusion lengths in both side of a transistor in a direction of the gate width.

In a method for designing a semiconductor integrated circuit in the present embodiment, gate protrusion lengths E1 and E2, lengths of the gate protrusion portion 103, are used as parameters for representing a transistor property in addition to the gate width Wg, the gate length Lg, a length of the active region 101.

In the method for designing, modeling of change rate of a saturated current value is executed by using the following expression (1), which means that a change rate ΔIdsat/Idsat of a saturated current value is inversely proportionate to the distance between the end of the gate protrusion portion 103 and an effective center in a gate width direction.

ΔIdsat/Idsat∝1/(E1+A×Wg)+1/(E2+A×Wg) (1)

While in this expression A is 0≦A≦1, A is more preferable in 0.1≦A≦0.5 for improving simulation accuracy and particularly preferable when A=0.3. Grounds by which the above mentioned expression (1) is derived will be described later.

In the method for designing in the present embodiment, an electric property of an actual device is measured first, and a property expression representing a change rate of a saturated current value is derived from the result by using the above mentioned expression (1).

### —Derivation of a Model Expression—

Next, grounds by which the above mentioned expression (1) is derived will be described.

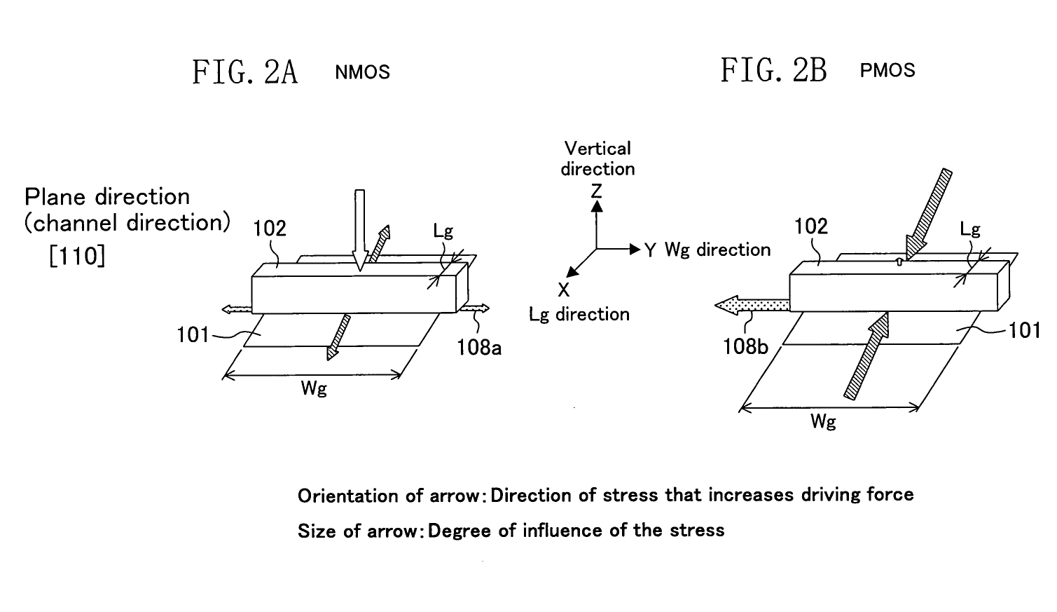

A phenomenon where a transistor property varies depending on a gate protrusion length of a gate electrode will be explained qualitatively with use of FIG. 1 and FIG. 2. FIGS. 2A and 2B are perspective views explaining a relation between stress and carrier mobility in transistors.

As shown in FIG. 1, in the transistor 104, since the shorter the gate protrusion length E1 and E2 are, the larger the compressive stress 107 applied to the gate protrusion portion 103 becomes depending on a contracting effect (compressive stress 106), compressive stress in a gate width direction applied to an end in the gate width direction of the active region 101 also becomes larger. Meanwhile, since the longer the gate protrusion length E1 and E2 are, the smaller the compressive stress 107 applied to the gate protrusion portion 103 becomes, compressive stress in a gate width direction applied to an end in the gate width direction of the active region 101 is reduced.

As shown in FIG. 2, a relation between a direction of stress applied to a channel region of a transistor and driving force of a transistor varies depending on a type of a transistor (N channel type or P channel type). In addition, a relation between a direction of stress applied to a channel region of a transistor and the driving force varies depending on a plane direction of a channel direction. FIG. 2 shows a case where a plane direction of the channel direction is [1 1 0]. In the figure, directions of stresses 108a and 108b that increase the driving force of the transistor are shown by arrows, and a direction of the arrows shows a direction in which the driving force increases and a size of the arrows shows a degree of its effects.

As is clear from FIGS. 2A and 2B, for a Lg direction and a vertical direction, the direction of stress that increases the driving force and the size of the arrows are different between an N channel type MOS transistor and a P channel type MOS transistor. Meanwhile, for the gate width direction, the direction of stress that increases the driving force is the same between the P channel type and the N channel type. It is noted, however, for the gate width direction, the P channel type is more largely influenced than is the N channel type.

Thus, the transistor property varies depending on compressive stress in the gate width direction mainly caused by contraction of the side wall 105.

At this moment, since the compressive stress in the gate width direction is considered to be reduced in inverse proportion to the distance between the end of the gate protrusion portion 103 and an effective center in a gate width direction, a change rate ΔIdsat/Idsat of a saturated current value of the transistor 104 can be considered to be inversely proportionate to the distance between the end of the gate protrusion portion 103 and an effective center in a gate width direction. Here, it is assumed that stress and mobility are proportionate to each other. The “effective center in a gate width direction of a transistor” means a position where stress applied from both ends of the gate width direction in a gate electrode of the transistor can be assumed to be average stress.

As a result, in the transistor 104 shown in FIG. 1, the gate protrusion length dependency of the change rate ΔIdsat/Idsat of a saturated current value is shown as the above mentioned expression (1). At this moment, when the effective center in a gate width direction of a transistor is determined to be simply the physical center of the gate width of the transistor, A can be determined as 0.5, and thus the expression (1) is as shown below.

ΔIdsat/Idsat∝1/(E1+0.5×Wg)+1/(E2+0.5×Wg) (2)

Next, it will be explained that the model expressions (1) and (2) are highly accurate reflections of an actual device property.

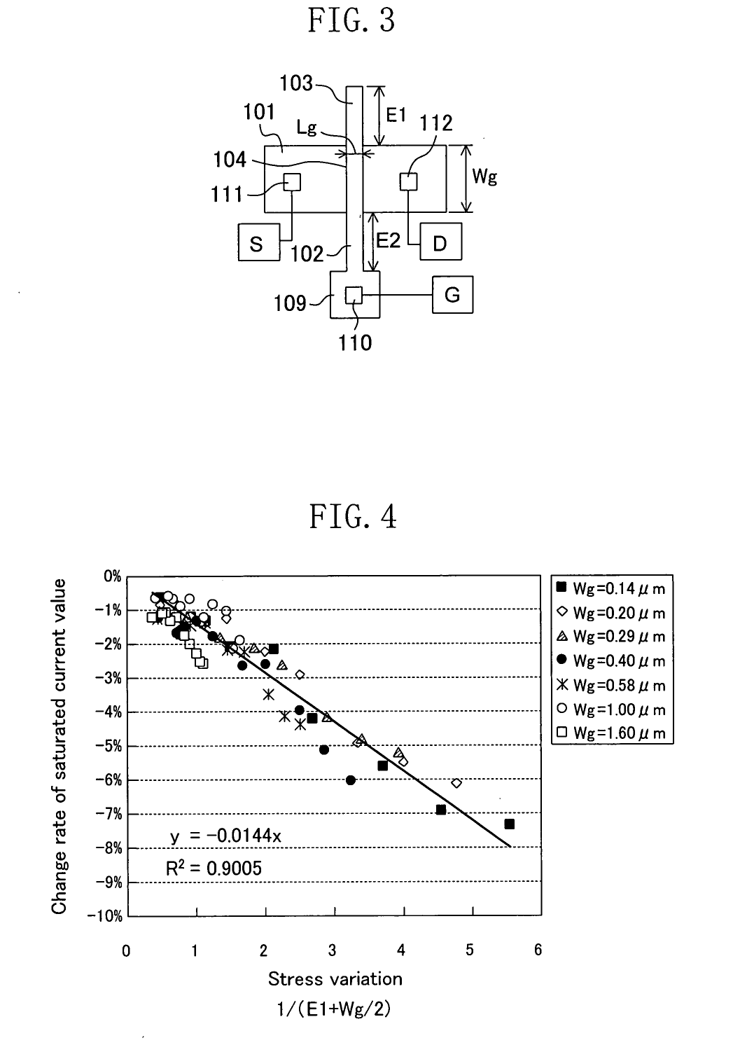

FIG. 3 is a plan view showing an example of a pattern for evaluating effects given to a transistor property by a gate protrusion length. The transistor 104 shown in the figure includes the active region 101 surrounded by an element isolating insulation filter and the gate electrode 102 as in the example shown in FIG. 1. Furthermore, a source contact 111 and drain contact 112 arranged so as to interleave the gate electrode 102 on the active region 101, and a gate contact 110 arranged on one end of the gate electrode 102 are further included in a pattern shown in the figure. In addition, the gate contact pad 109 for connecting to the gate contact 110 is arranged on one end of the gate electrode 102. The end without the gate contact pad 109 of the gate electrode 102 is the gate protrusion portion 103 protruding from the active region 101. In FIG. 3, Lg denotes a gate length, Wg denotes a gate width, E1 denotes a gate protrusion length on upper side (on a side where the gate contact pad is not provided) of the transistor 104, and E2 denotes a gate protrusion length on under side of the transistor 104. The gate electrode 102 is connected to a gate terminal via the gate contact pad 109, the gate contact 110, and a wiring in upper layer. The active region 101 is connected to a source terminal and a drain terminal via a source contact 111, a drain contact 112, and a wiring in upper layer. Although not shown in the figure, a substrate terminal is connected to an active region, other than the active region 101, which has a polarity opposite to that of the active region 101.

The inventors of the present invention evaluated electric properties of these transistors after manufacturing a plurality of transistors with the configuration shown in FIG. 3 and where E2 is fixed to be constant by fixing a shape of the gate contact pad 109 while varying E1. A relation between a change rate of a saturated current value and the gate protrusion length E1 can be described as a following expression (3) because the extent of contribution of E2 in the expressions (1) and (2) is constant.

ΔIdsat/Idsat∝1/(E1+0.5×Wg) (3)

A result obtained by evaluating the correctness of the expression (3) with use of an actual transistor is shown below. FIG. 4 is a graph showing a relation between a gate protrusion length E1 and a change rate of a saturated current value. Here, (change rate of a saturated current value ΔIdsat) is equal to {(saturated current value when E1 is infinite) minus (saturated current value Idsat)}. In FIG. 4, a transistor experimentally manufactured in process of 65 nm generation is evaluated, and the gate length Lg is 0.06 μm. In the figure, plotting is made with the gate protrusion length E1 and the gate width Wg as parameters, and a value of the gate protrusion length E1 is varied from 0.11 μm to 2 μm and a value of the gate width Wg is varied from 0.14 μm to 1.6 μm.

The result shown in FIG. 4 shows that the ΔIdsat/Idsat is approximately proportionate to (E1+0.5×Wg) and modeling is successfully accomplished for various values of the E1 and the Wg. Accuracy of an expression made by modeling with collinear approximation can be evaluated by using square of a correlation coefficient, i.e., a determination coefficient R², and the closer a value of the R² is to 1, the higher the accuracy is. Since a value of the R² relative to the expression (3) modeling in FIG. 4 is 0.9, the accuracy of the modeling using the expression (3) has been proven to be sufficiently high.

While Wg is multiplied by a coefficient 0.5 using the center of the gate width of the transistor as a criterion, the coefficient A of the Wg may be not be limited to 0.5 but can be set within a range 0≦A≦1 at least using a position where a channel is formed as a criterion.

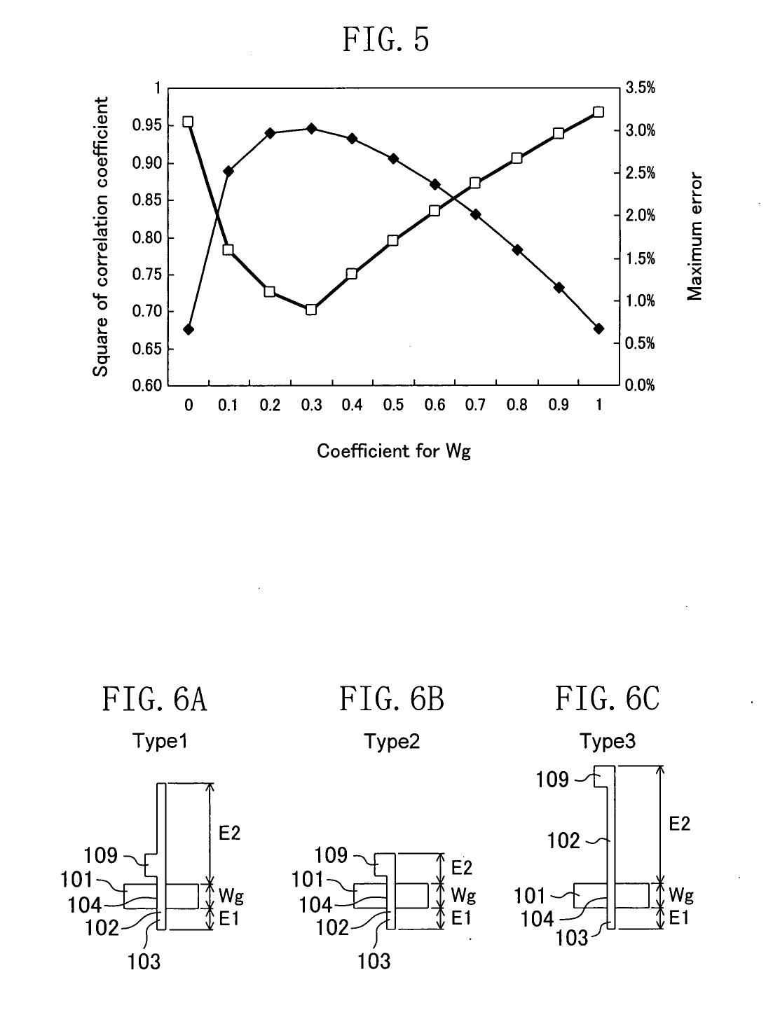

FIG. 5 shows a relation between a coefficient regarding the gate width Wg and a correlation coefficient and error in the expression (3). A horizontal axis in the figure shows the coefficient of the Wg, temporarily determined as 0.5 in the Expression (3).

When a coefficient A regarding the Wg was varied from 0 through 1 in FIG. 5, R² became more than 0.9 in a case where the coefficient A was from 0.1 to 0.5. R² had a maximum value of 0.95 when the coefficient A was 0.3. In addition, it was realized that error was less than 2% when the coefficient A was from 0.1 to 0.5. A vertical axis on the right side in FIG. 5 shows a maximum error arose between respective measurement values and a linear approximated line. While a range of the coefficient A regarding the Wg cannot be clearly defined, a value of R² which is equal to or more than 0.9 is sufficiently high value in general, and an error equal to or less than 2% may serve as a standard of modeling. According to “The International Technology Roadmap for Semiconductors 2003”, a modeling error of a saturated current value is aimed to be within 5%. Therefore, an aimed error within 2% to one model parameter in dependency of an electric property is not so senseless value. Accordingly, in the method for designing in the present embodiment, it is preferable to determine a coefficient of the Wg in the expression (1) as a value from 0.1 to 0.5 in order to improve simulation accuracy.

As described above, it has been proved that the change rate of a saturated current value ΔIdsat/Idsat is inversely proportionate to a product of the gate protrusion length E1 and the gate width Wg of a transistor and a coefficient, and that modeling for estimating effects given to a transistor property by a gate protrusion length can be executed with high accuracy by using a simple model expression. In addition, it has been shown that a coefficient regarding the Wg has an optimum value equal to or more than 0.1 and equal to or less than 0.5 in the model expression. By using the above mentioned method for designing, a highly accurate circuit simulation taking into consideration the gate protrusion length of a gate electrode is realized.

This method is effective for designing a circuit that has a transistor having a gate electrode including a side wall, and for the case where a component of the side wall is other than SiN.

### Second Embodiment

### —Procedure of a Method for Designing—

As a second embodiment of the present invention, a modeling method for a complicated gate wiring pattern used in an actual LSI will be explained. Two patterns of a gate contact pad shape and a bent wiring shape are considered as a complicated gate wiring pattern. By considering the two patterns, all gate wiring patterns can be dealt with.

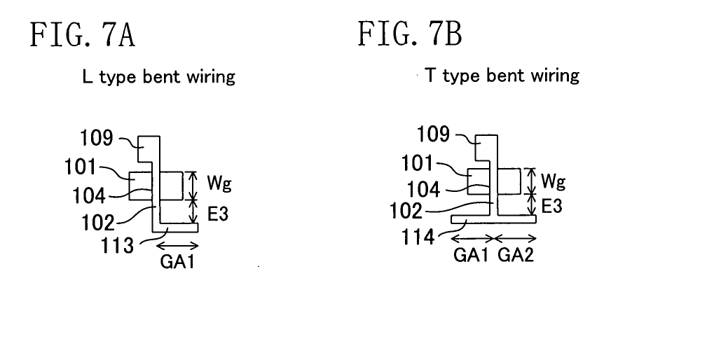

FIGS. 6A to 6C are views showing examples of patterns of transistors having a gate electrode 102 with a gate contact pad 109. In the figures, a length of one end of the gate electrode 102 with the gate contact pad 109 is a gate protrusion length E2, and a length of another end of the gate electrode 102 is a gate protrusion length E1. In addition, FIG. 7A shows a pattern of a transistor 104 whose one end has a gate contact pad 109 and whose another end has a L type bent wiring 113, and FIG. 7B shows a pattern of a transistor 104 whose one end has a gate contact pad 109 and whose another end has a T type bent wiring. In FIG. 7, a length from an active region 101 to a bent portion of the gate electrode is E3, and a length from the bent portion to an end of the gate electrode 102 is GA1 and GA2.

In a method for designing a semiconductor integrated circuit in the present embodiment, modeling is executed to a complicated gate wiring pattern in the following manner. Grounds and reasons why this method is employed will be described below.

In a first step, profile of a gate protrusion portion other than apexes positioned over an active region are extracted from a layout data of a semiconductor integrated circuit by using the LPE.

Next, in a second step, it is determined whether a gate contact pad is formed in the gate protrusion portion, and whether the gate protrusion portion forms a bent wiring. Specifically, the number of apexes extracted in the first step is identified, and when there are more than three apexes, the modeling is executed assuming that a gate protrusion length of the gate protrusion portion is infinite. When the number of apexes is two, modeling is executed with use of the expression (1) explained in the first embodiment. When the number of apexes of the gate protrusion portion other than apexes positioned over an active region is two, it is meant that a gate contact pad is not formed in a corresponding portion of a gate electrode and a corresponding portion of the gate electrode does not form a bent wiring. On the other hand, when the number of apexes of the gate protrusion portion other than apexes positioned on an active region is three or more, it is meant that a gate contact pad is formed in a corresponding portion of a gate electrode or a corresponding portion of the gate electrode forms a bent wiring. As described above, when a gate contact pad and a bent wiring are present, it becomes difficult to apply compressive stress to a channel region from a side wall formed in these portions. Therefore, a gate protrusion length can be assumed to be infinite. In this step, by recognizing apexes in a gate protrusion portion and determining the number of the apexes, modeling can be easily executed even to a complicated wiring pattern with use of a device such as the LPE and commercially available tools.

In the second step, when the number of apexes of the gate protrusion portion other than apexes positioned over an active region is two, modeling may be executed assuming that a gate protrusion length is infinite in a case where the gate protrusion length E1 is equal to or more than 1 μm. As a result, the amount of calculation required in parameter extraction and the like can be reduced and time required in the extraction can be shortened.

In the second step, modeling may be executed by using a function including the distance E3 from the active region 101 shown in FIGS. 7A and 7B to the L type bent wiring 113 or the T type bent wiring (bent portion) and the gate wiring length GA1. That is to say, after obtaining a polynomial expression including E3 and GA1 processed by the fitting so as to fit actually measured data, modeling may be executed with use of the polynomial expression. Modeling may be executed with creating a reference table. Furthermore, modeling using a model expression incorporating a gate wiring width as a parameter may be executed.

According to the method described above, a property of a transistor including a complicated pattern can be accurately estimated, and, as a result, a simulation of a semiconductor integrated circuit can be easily and accurately executed.

### —Grounds for the Method for Designing—

Next, in the method for designing of the present embodiment described above, a gate protrusion length can be assumed to be infinite and effects of stress from a corresponding gate protrusion portion can be ignored when a gate contact pad is formed in the gate protrusion portion or when the gate protrusion portion forms a bent wiring. The reason will be explained below.

First, a pattern for evaluating effects given to a transistor property by a shape of a complicated gate wiring will be described. FIGS. 6A to 6C are views showing patterns for evaluating effects given to a transistor property by a shape of a gate contact pad, and FIGS. 7A and 7B are views showing patterns for evaluating effects given to a transistor property by a shape of a bent wiring. The transistor 104 shown in FIG. 6 and FIG. 7 includes the active region 101 formed in a semiconductor substrate and the gate electrode 102 provided on the semiconductor substrate so as to cross the active region 101 with interleaving a gate insulation film. A portion of a plan profile of the gate electrode 102 protruding beyond the active region 101 is shown as the gate protrusion portion 103 in FIG. 6 and FIG. 7. In FIG. 6 and FIG. 7, Wg denotes a gate width, E1 denotes a gate protrusion length in lower side in the figures, E2 denotes a gate protrusion length in upper side in the figures, E3 denotes a distance between the active region 101 and the L type bent wiring 113 or the T type bent wiring 114, and GA1 and GA2 denote gate wiring lengths in the L type bent wiring 113 or the T type bent wiring 114, respectively. Although the gate contact, the source contact, and the drain contact shown in FIG. 3 are not shown in the figures, the gate electrode 102 is connected to a gate terminal by a wiring in upper layer via the gate contact, the active region 101 is connected to a source terminal via the source contact and the wiring in upper layer and to a drain terminal via the drain contact and the wiring in upper layer, respectively.

The inventors measured properties of transistors having three kinds of gate patterns including Type 1 to Type 3 shown in FIGS. 6A to 6C in order to examine effects given to a transistor property by a position of a gate contact pad seen from the active region 101. Also examined were effects of stress applied from a gate protrusion length, with varying E1 and fixed E2, in the absence of a gate contact pad and a bent wiring. In the Type 1 shown in FIG. 6A, a contact pad is positioned in an approximately central portion of a gate electrode. In the Type 2 and Type 3 shown in FIGS. 6B and 6C, an end of a gate electrode overlaps a contact pad. In addition, E2 in the Type 3 is larger than E2 in the Type 2. E2 in the Type 2 is 0.25 μm and E3 in the Type 3 is 1.0 μm. In many cases of an actual LSI, other active regions are further arranged in an upper portion in a direction of a gate width of the active region 101 shown in the figure in the Type 1 and the Type 3, and actual measurement pattern is also arranged. However, since a result is not essentially influenced by the arrangement, only E1 is varied with a fixed shape of the gate contact pad 109 in respective patterns of the Type 1 to the Type 3 and constant E2 in respective patterns so that a measurement result can be easily analyzed.

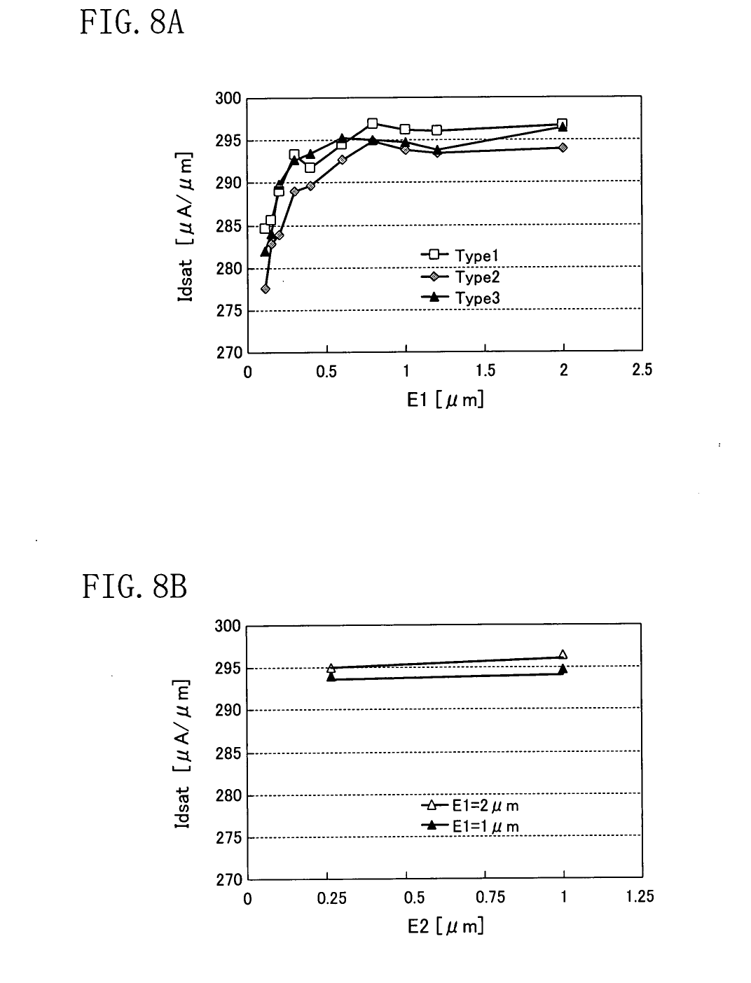

FIG. 8A is a view showing a measurement result of a relation between a shape of the gate contact pads and saturated current value of the transistors, and FIG. 8B is a view showing a measurement result of a relation between a gate protrusion length and a saturated current value when the gate contact pads and the bent wirings are not provided. Types 1 to 3 shown in FIG. 8A are the same as those shown in FIGS. 6A to 6C. Evaluated gate length Lg and gate width Wg of a transistor are 0.06 μm and 0.4 μm, respectively. In FIG. 8A, a horizontal axis represents the gate protrusion length E1 and a vertical axis represents a saturated current value a unit length. In addition, FIG. 8A shows a transistor property in a case where the gate protrusion length E2 in upper side in the figure is changed in patterns of the Type 2 and the Type 3.

The result in FIG. 8A shows that there is substantially no change in the changing pattern of a saturated current value relative to a gate protrusion length in patterns of the Type 1 to the Type 3. That is to say, in each case of the Type 1 to the Type 3, it is realized that a value of the saturated current Idsat monotonically increases in a range where the gate protrusion length E1 is less that 1 μm as the E1 increases, and that there is substantially no change in the saturated current value when the E1 exceeds 1 μm. Accordingly, it is realized that the gate protrusion length E1 can be assumed to be infinite when the gate protrusion length E1 exceeds 1 μm. It is believed that this can be applied to the case where a distance between a gate contact pad and the active region 101 is equal to or more than 1 μm.

Furthermore, the result shown in FIG. 8A shows that a saturated current value is not dependent on E2. In the pattern of the Type 3, since the gate protrusion length E2 on one side is 1 μm, the gate protrusion length E2 can be assumed to be infinite. Meanwhile, since there is substantially no different between saturated current values in the Type 1 and the Type 2 and a saturated current value of the pattern in the Type 3, it is realized that a gate protrusion length can be assumed to be infinite when a shape of a gate contact pad exists.

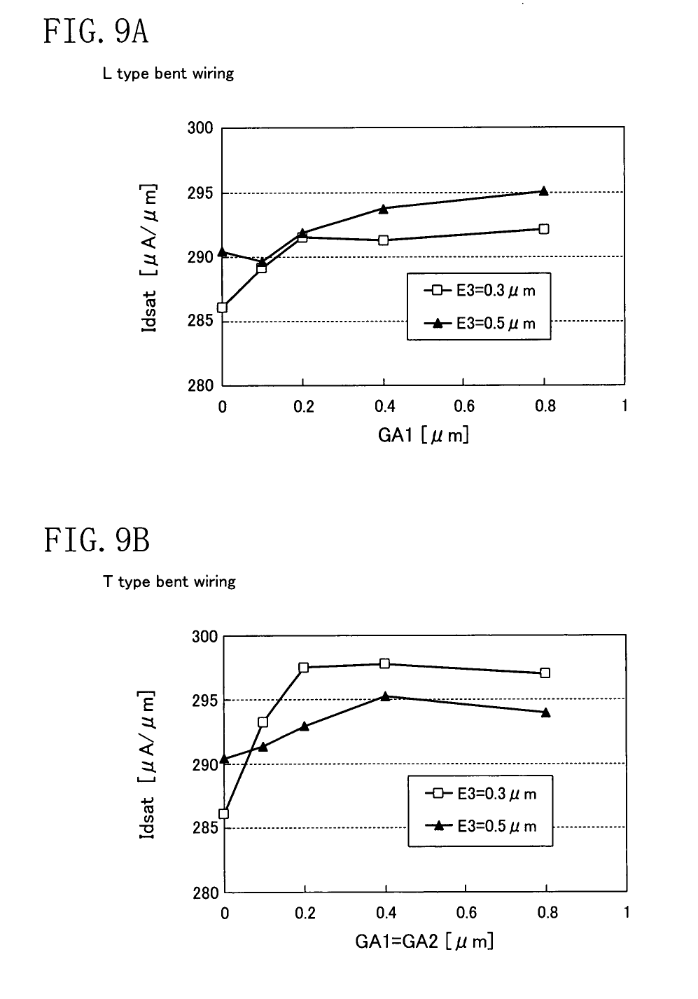

FIG. 7A is a pattern that models a L type bent wiring, and FIG. 7B is a pattern that models a T type bent wiring. FIGS. 9A and 9B are views showing a relation between a shape of the L type bent wiring shown in FIG. 7A and a saturated current value per a unit length, and a relation between a shape of the T type bent wiring shown in FIG. 7B and a saturated current value per a unit length. Evaluated gate length Lg and gate width Wg of a transistor are 0.06 μm and 0.4 μm, respectively. In FIG. 9, a horizontal axis represents a gate wiring length (from a bent point to an end of a gate electrode) and a vertical axis represents a saturated current value. Additionally, in a gate wiring length of a transistor measured in FIG. 9B, GA1 is equal to GA2.

The result shown in FIG. 9A shows that in a transistor in which a gate protrusion portion is configured to be the L type bent wiring, there is substantially no change in a saturated current value when the GA1 is equal to or more than 0.2 μm. In addition, the result shown in FIG. 9B shows that in a transistor in which a gate protrusion portion is configured to be the T type bent wiring, there is substantially no change in a saturated current value when the GA1 and the GA2 are equal to or more than 0.2 μm. It is also shown that effects given to a transistor property by the distance E3 from the active region 101 to the L type bent wiring 113 or the T type bent wiring 114 are smaller than effects given to a transistor property by the gate wiring length.

As a result, it is realized that saturated current values are approximately the same as the saturated value at which the gate protrusion length E1 can be assumed to be infinite in the case of GA1>0.2 μm when a gate protrusion portion is the L type bent wiring, and in the case of GA1=GA2>0.2 μm when the gate protrusion portion is the T type bent wiring. Since a pattern of GA2>0.2 μm is often the case in actual circuit design, it is realized that a gate protrusion length of a gate protrusion portion having the pattern can be assumed to be infinite within a range of a parameter in actual design if there is a pattern of the L type or the type bent.

In aforementioned explanation, effects given to a transistor property by the distance E3 from the active region 101 to the L type bent wiring 113 or the T type bent wiring 114 are assumed to be relatively small: however, modeling of dependency of a transistor property on a gate wiring length is desirable if high accuracy is to be further achieved. It is only necessary to execute modeling by a function of the gate wiring length GA1 and the distance E3 between the active region 101 and the L type bent wiring 113 or the T type bent wiring 114. In this case, it is only necessary to subject an expression using a general polynomial expression including the E3 and the GA1 to fitting so as to fit to actually measured data. In addition, it can be treated in a table reference model. Since a gate wiring width, not shown, is also an important parameter to estimate a transistor property, it is preferable to add the gate wiring width to a modeling expression for further high accuracy.

Next, a reason that effects of stress from a bent wiring are smaller than effects of stress from a linear gate protrusion portion will be described below.

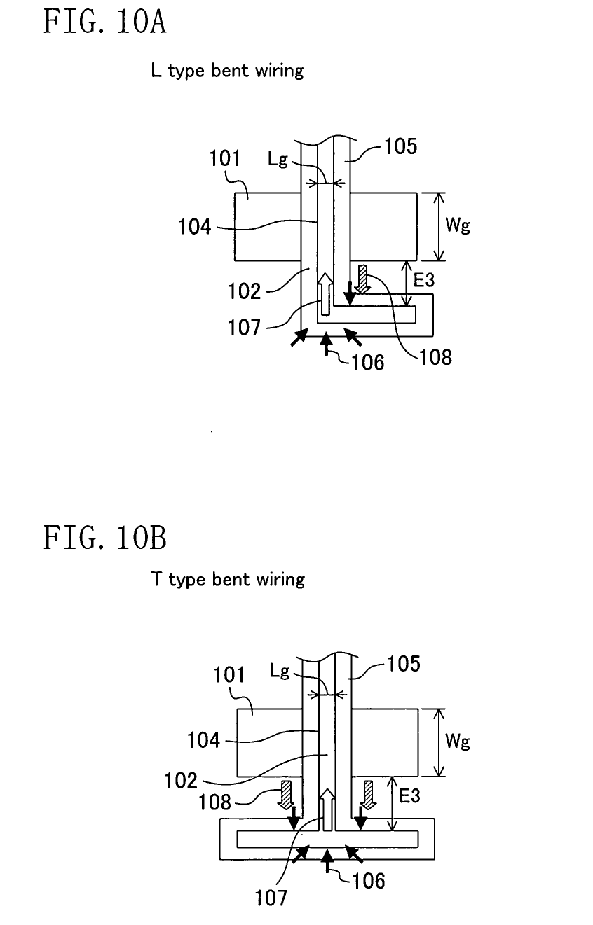

FIGS. 10A and 10B are views explaining how stresses are applied in the L type and the T type bent wirings, respectively. In the figure, reference numeral 101 denotes a active region, 102 denotes a gate electrode, 104 denotes a transistor, 105 denotes a side wall made of insulating substance such as SiN, 106 denotes compressive stress which is applied when the side wall contracts and which reduces driving force of the transistor, 107 denotes compressive stress transmitted into a gate protrusion portion 103, 108 denotes stress which increases driving force of the transistor 104, Lg represents a gate length, Wg represents a gate width, and E3 represents the distance between the active region 101 and the L type bent wiring 113 or the T type bent wiring 114.

As can be seen from FIGS. 10A and 10B, it is realized that when a bent wiring exists, a component of tensile stress arises as seen from a transistor. Since compressive stress and tensile stress negate each other, effects given to a transistor property by the distance E3 between the active region 101 and the L type bent wiring 113 or the T type bent wiring 114 are small as a result. In addition, since a T type bent wiring generates large tensile stress than does an L type bent wiring, the driving force of a transistor becomes strong. Since the longer the distance E3 to the T type bent wiring 114 is, the smaller a saturated current value is, it is realized that a transistor property deteriorates (see FIG. 9B).

According to the reasons explained above, in the method for designing of the present embodiment, if a gate contact pad and a bent wiring exist, modeling taking into consideration only the gate protrusion length on one side can be executed while assuming a gate protrusion length to be infinite. In addition, in a case where a shape of a gate protrusion portion is linear, a gate protrusion length can be assumed to be infinite if the gate protrusion length is equal to or more than 1 μm.

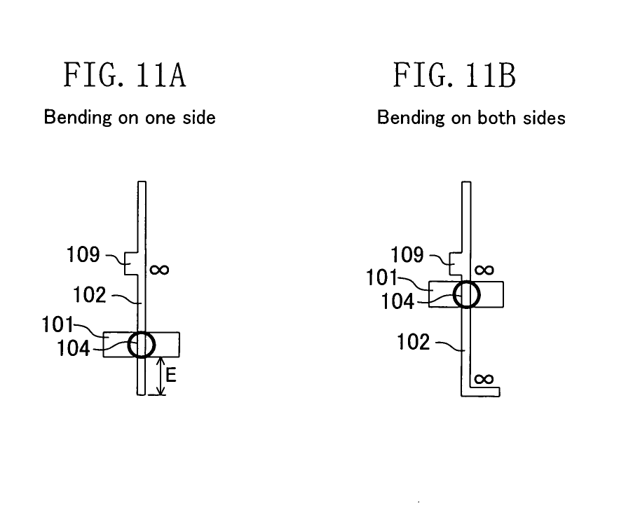

FIGS. 11A and 11B are views showing a pattern classification applied to a complicated gate wiring pattern in an actually designed LSI. FIG. 11A shows a case where a bent wiring exists only on one side as seen from the active region, and 11B shows a case where bent wirings exist on both sides as seen from the active region. Since it is required for a gate electrode to be connected to a contact, a contact pad portion is required. Accordingly, a gate contact pad or a bent wiring for connecting to the gate contact pad is necessarily formed in one of two ends of a gate electrode for one transistor. Therefore, one of two ends of a gate electrode can be necessarily assumed to be infinite, and modeling focusing on a gate protrusion portion of a shorter gate protrusion length can be executed. In addition, as shown in FIG. 11B, gate protrusion lengths of both gate protrusion portions may be treated as infinite lengths when the gate contact pad and the bent wiring exist on both sides as seen from the active region.

When a gate wiring length of a bent wiring is longer than a gate pitch in a semiconductor integrated circuit, effects given to a transistor from the bent wiring are saturated. In many cases, a gate wiring length is longer than a gate pitch. Also for this reason, it is realized that when a bent wiring exists, effects of stress given to a transistor from the wiring are saturated.

### Third Embodiment

As a third embodiment of the present invention, a method for executing a circuit simulation with use of the method for designing explained in the first and second embodiments.

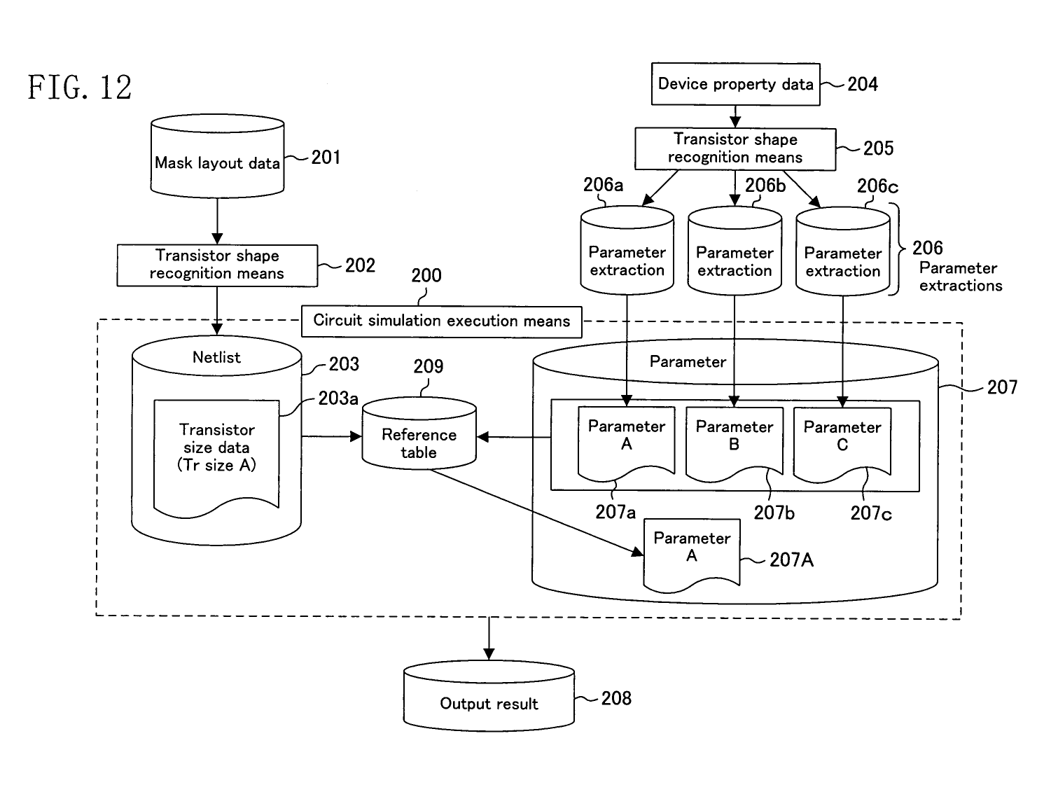

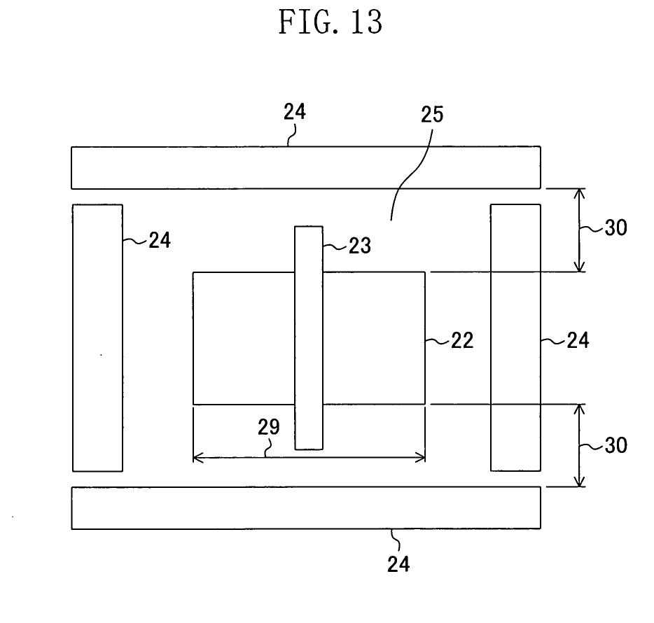

FIG. 12 is a block diagram showing a configuration of a circuit simulation device according to a third embodiment. As shown in the figure, the circuit simulation device includes a circuit simulation execution means 200.

A netlist extracted from a mask layout data 201 by designing tools or the like and a parameter 207 extracted from device property data 204 that is an actual measured value of a device property are inputted to the circuit simulation execution means 200.

Specifically, transistor size data 203a is extracted by a first transistor shape recognition means 202 from the mask layout data 201 having designing data of a circuit to be analyzed, and the transistor size data 203a is inputted to the circuit simulation execution means 200 as represented by the SPICE or the like as a netlist 203. In the first transistor shape recognition means 202, recognition of apexes of a graphical profile of a gate protrusion portion and count of the apexes are executed in addition to a gate length and a gate width. For example, when the number of apexes other than apexes over an active region is two, it is recognized that a simple gate protrusion portion exists, and when the number is 3 or more (actually 4 or more), it is recognized that some sort of bent wiring or gate contact pad exist. On this occasion, it is possible to recognize whether it is a bent wiring or a gate contact pad depending on existence or non-existence of a contact layer. In the circuit simulation method of the present embodiment, the first transistor shape recognition means 202 recognizes each gate protrusion portion and its gate protrusion length. When a bent wiring exists, the distance between an active region and the bent wiring, and a gate wiring length may be further extracted.

Data included in the parameter 207 is derived from an actually measured value, which is device property data 204, of an actual measurement device. In a case of a transistor, the device property data 204 defines a size based on a gate length Lg and a channel width (a gate width Wg), and measures an electric property on an actually measured transistor having a different size from each other. In the circuit simulation method of the present embodiment, a saturated current value is measured by changing conditions of the distance E3 from the gate protrusion length E1, E2, and the active region to the L type or T type bent wiring, and of a factor relating to a stress such as the gate wiring length GA1 with use of an actually measured transistor, for example, as shown in FIG. 6 and FIG. 7.

Next, with use of a second transistor shape recognition means 205 from the device property data 204, recognition is executed for the distance E3 from the gate protrusion length E1, E2, and the active region to the L type or T type bent wiring and for the gate wiring length GA1.

An operation of a plurality of parameter extractions 206 is executed to transistors with the same gate length Lg and channel width (gate width) Wg on the basis of the distance E3 from the gate protrusion length E1, E2, and the active region to the L type or T type bent wiring, and the gate wiring length GA1, extracted from the transistor shape recognition means 205. In FIG. 12, concerning three types of transistors to which different stresses are applied, an example of executing of the parameter extraction 206a, 206b, and 206c based on a stress parameter is shown. As described in the second embodiment, a gate protrusion length is treated as an infinite length when a gate contact pad and a bent wiring exist, and a parameter extraction is executed with use of a gate protrusion length of a gate protrusion portion in which both of a gate contact pad and a bent wiring are not formed. In addition, assuming that a gate protrusion length is infinite, a parameter extraction is executed even when the gate protrusion length is 1 μm or more. In a step of the parameter extraction 206, an operation which transposes the obtained device property data 204 into a parameter 207 having model parameter groups 207a, 207b, and 207c according to stress is executed. In this parameter extraction, a device modeling using the expression (1) described in the first embodiment is executed.

Next, a reference table 209 including data which contrasts a transistor included in an integrated circuit with parameters to be applied to the transistor is created on the basis of matters which can be indicators of stress applied to the transistor. An optimum parameter 207A corresponding to the transistor size data 203a is selected based on data of the reference table 209, and an operation of a circuit is simulated by the circuit simulation execution means 200.

Herewith, an output result 208 of the circuit simulation reflecting effects given to the transistor from a gate protrusion portion is obtained.

The transistor size data 233a included in the netlist 203 may be preliminarily corrected without the reference table.

According to the circuit simulation method of the present embodiment, a highly accurate circuit simulation taking into consideration effects of stress applied from a gate protrusion portion can be executed with relatively a small amount of calculation by, for example, assuming that a gate protrusion length is infinite when a gate contact pad and a bent wiring exist.

The method for designing and the circuit simulation method of the present invention described above are used for designing an integrated semiconductor circuit device such as LSI.

What is claimed is:

1. A method for designing a semiconductor integration circuit, the semiconductor integration circuit including a transistor having an active region and a gate electrode, the gate electrode crossing the active region and including a gate protrusion portion having a plan profile protruding beyond both sides of the active region, the method comprising a step (a) of executing modeling by using an inverse proportion between a change rate of a saturated current value of the transistor and a sum of a gate protrusion length and a product of a gate width of the transistor and a coefficient A, the gate protrusion length being the length of the gate protrusion portion.

2. The method for designing a semiconductor integration circuit according to claim 1, wherein the coefficient A for the gate width is from 0.1 and to 0.5.

3. The method for designing a semiconductor integration circuit according to claim 1, wherein:
the step (a) includes a step (a1) of recognizing apexes of a graphical profile of the gate protrusion portion and counting the number of apexes obtained by subtracting the number of apexes positioned over the active region from the recognized apexes; and
when the number of apexes counted in the step (a1) is two, modeling is executed by using an inverse proportion between the change rate of the saturated current value of the transistor and a sum of the gate protrusion length and a product of the gate width of the transistor and the coefficient A, provided that the gate protrusion length is at least within a predetermined range.

4. The method for designing a semiconductor integration circuit according to claim 3, wherein in the step (a), when the number of apexes counted in the step (a1) is equal to or more than three, modeling is executed under the assumption that the gate protrusion length is infinite.

5. The method for designing a semiconductor integration circuit according to claim 4, wherein a gate contact pad for connecting to a contact is formed in the gate protrusion portion, the number of apexes thereof counted in the step (a1) being equal to or more than three.

6. The method for designing a semiconductor integration circuit according to claim 4, wherein a bent wiring is formed in the gate protrusion portion, the number of apexes thereof counted in the step (a1) being equal to or more than three.

7. The method for designing a semiconductor integration circuit according to claim 6, wherein a gate wiring length of the bent wiring is longer than a gate pitch in the semiconductor integrated circuit.

8. The method for designing a semiconductor integration circuit according to claim 1, wherein in the step (a), when the gate protrusion length is equal to or more than 1 μm, modeling is executed under the assumption that the gate protrusion length is infinite.

9. The method for designing a semiconductor integration circuit according to claim 3, wherein in the step (a), when the number of apexes counted in the step (a1) is equal to or more than three and the gate protrusion portion forms a bent wiring, modeling is executed by using a polynomial expression including a distance between the active region and a bent portion, and a gate wiring length.

10. The method for designing a semiconductor integration circuit according to claim 9, wherein the polynomial expression used in the step (a1) further includes a gate wiring width.

11. A circuit simulation method of a semiconductor integration circuit, the semiconductor integration circuit including a transistor having an active region and a gate electrode, the gate electrode crossing the active region and including a gate protrusion portion having a plan profile protruding beyond both sides of the active region, the method comprising the steps of:
a step (a) of extracting, from mask layout data, transistor size data including a gate length, a gate width, a gate protrusion length of the gate protrusion portion, and the number of apexes obtained by subtracting the number of apexes positioned over the active region from apexes of the gate protrusion portion;
a step (b) of inputting the transistor size data extracted in step (a) to a circuit simulation execution means;
a step (c) of obtaining device property data including a saturated current value by measuring electric properties of a plurality of actually measured transistors having different gate protrusion lengths;
a step (d) of executing a parameter extraction with respect to a saturated current of the plurality of actually measured transistors from the device property data using the gate length and the gate width of the plurality of actually measured transistors, and a parameter of stress applied from the gate protrusion portion, the parameter including the gate protrusion length of the gate protrusion portion;
a step (e) of inputting the parameter extracted in step (d) to the circuit simulation execution means; and
a step (f) of simulating an operation of the semiconductor integrated circuit with use of the transistor size data and a parameter inputted in step (e), the simulation being executed by the circuit simulation execution means, wherein
in the step (c) and the step (d), modeling is executed with respect to each of the plurality of actually measured transistors by using an inverse proportion between a change rate of a saturated current value of each actually measured transistor and a sum of the gate protrusion length and a product of the gate width of each actually measured transistor and a coefficient A.

12. The circuit simulation method of a semiconductor integrated circuit according to claim 11, wherein the coefficient A is from 0.1 to 0.5.

13. The circuit simulation method of a semiconductor integrated circuit according to claim 12, wherein:
the step (c) includes a step (c1) of recognizing apexes of a graphical profile of the gate protrusion portion of each actually measured transistor and counting the number of apexes obtained by subtracting the number of apexes positioned over the active region from the recognized apexes; and
when the number of apexes counted in the step (c1) is two, modeling is executed by using an inverse proportion between the change rate of the saturated current value of each actually measured transistor and a sum of the gate protrusion length and a product of the gate width of each actually measured transistor and the coefficient A, provided that the gate protrusion length is at least within a predetermined range.

14. The circuit simulation method of a semiconductor integrated circuit according to claim 13, wherein the step (c) including, when the number of apexes counted in the step (c1) is equal to or more than three, executing modeling under the assumption that the gate protrusion length of each actually measured transistor is infinite.

15. The circuit simulation method of a semiconductor integrated circuit according to claim 13, wherein a gate contact pad for connecting to a contact is formed in the gate protrusion portion, the number of apexes thereof counted in the step (c1) being equal to or more than three.

16. The circuit simulation method of a semiconductor integrated circuit according to claim 13, wherein a bent wiring is formed in the gate protrusion portion, the number of apexes thereof counted in the step (c1) being equal to or more than three.

17. The circuit simulation method of a semiconductor integrated circuit according to claim 13, wherein in the step (c), when gate protrusion length of each actually measured transistor is equal to or more than 1 μm, modeling is executed under the assumption that the gate protrusion length is infinite.
